(19) United States
(12) Patent Application Publication
(10) Pub. No.: US 2024/0149529 A1
(43) Pub. Date: May 9, 2024

(54) DEVICE AND METHOD FOR PRODUCING THREE-DIMENSIONAL SHAPED PARTS

(71) Applicant: VOXELJET AG, Friedberg (DE)

(72) Inventors: Ingo Ederer, Geltendorf (DE); Daniel Günther, München (DE)

(21) Appl. No.: 18/415,920

(22) Filed: Jan. 18, 2024

Related U.S. Application Data
(63) Continuation of application No. 15/759,703, filed on Mar. 13, 2018, now Pat. No. 11,890,810.

(30) Foreign Application Priority Data
Sep. 16, 2015 (DE) 10 2015 011 790.4

(51) Int. Cl. B29C 64/321; B23K 10/02; B29C 64/209; B29C 64/232; B29C 64/245; B29C 64/255; B29C 64/268

(52) U.S. Cl. CPC B29C 64/321; B23K 10/027; B29C 64/209; B29C 64/232; B29C 64/245; B29C 64/255; B29C 64/268; B29C 2791/002; B29C 2791/009

(57) ABSTRACT

The invention relates to a device and a method for producing three-dimensional shaped parts by means of a layer construction method on a construction field in a construction space of a device, wherein materials are supplied to and discharged from the construction space. A supplying and discharging of all materials is carried out in a spatial direction of the device.

The invention relates to a device and a method for producing three-dimensional molded parts by a layer construction method on a construction field in a construction space of a device, wherein materials are fed to and removed from the construction space.

European Patent EP 0 431 924 B1 describes a process for producing three-dimensional objects based on computer data. In the process, a thin layer of particulate material is deposited on a platform by means of a coater (recoater) and has a binder material selectively printed thereon by means of a print head. The particulate region with the binder printed thereon bonds and solidifies under the influence of the binder and, optionally, an additional hardener. Next, the construction platform is lowered by one layer thickness or the coater/print head unit is raised and a new layer of particulate material is applied, the latter also being printed on selectively as described above. These steps are repeated until the desired height of the object is achieved. Thus, the printed and solidified regions form a three-dimensional object (molded part).

Upon completion, the object made of solidified particulate material is embedded in loose particulate material, from which it is subsequently freed. For this purpose a suction device may be used, for example. This leaves the desired objects which then have to be freed from any powder adhering to them, e.g. by brushing them off manually.

3D printing on the basis of pulverulent materials and the introduction of liquids using a print head is the quickest method among the layer construction techniques.

This method allows the processing of different fluids, such as particulate materials, for example, which includes—as a non-exhaustive example—natural biological raw materials, polymeric plastic materials, metals, ceramics and sands.

Other powder-based rapid prototyping processes, e.g. selective laser sintering or electron beam sintering, work in a similar manner, also applying loose particulate material layer by layer and selectively solidifying it using a controlled physical source of radiation.

Moreover, there are further methods, such as e.g. Fused Deposition Modeling (FDM) layer construction methods, wherein the cross-sections of each part are constructed using a liquid medium which solidifies outside a nozzle, changing the position of the construction platform by one layer thickness with respect to the previous position, and repeating these steps until the part is finished.

In the following, all these processes will be summarized by the term “layer construction method”, “three-dimensional printing method” or “3D printing method”.

Methods of the type described in this disclosure may comprise, for example, the Fused Deposition Modeling technique, stereolithography, laser sintering or laser melting, multijet or polyjet modeling, high-speed sintering or multijet fusion methods as well as binder jetting (FIG. 1 and FIG. 2).

Many prior art methods and devices use construction containers (104) or construction platforms (102), onto which construction material is applied during a construction process, for example by means of a powder coater (101) and a print head (100), and which carry at least the desired parts (103) upon completion of the construction process. In addition, there may also be a certain amount of unused construction material remaining in the construction container (104) or on the construction platform. In many cases, these construction containers (104) may be removed from the production machine (300) and exchanged. This allows a high degree of machine utilization.

The construction containers (104) and/or platforms (102) can be pulled out of the machine or moved out automatically in a certain direction. This is usually done manually in a horizontal direction. Outside the construction field, in some devices, they are picked up by a handling device and, if necessary, fed to further processing devices. The latter may be, for example, a lift truck by which the container is transported to another station. Such design requires plenty of space in front of the production machine (300).

The construction material is also fed to the machine via containers. These containers may be, for example, silos in the case of powders, or canisters in the case of liquids. Fused Deposition Modeling often involves inserting a roll of construction material into the machine.

What all of the prior art methods have in common is the fact that the starting material is handled by completely different mechanisms than the construction container (104). The movement directions of the respective handling operations are usually perpendicular to one another and are performed from different sides of the device. In Fused Deposition Modeling, e.g. in large systems, the construction platform is removed from the front using a cart. However, the construction material is fed to the machine manually, as a role, from the side.

In binder jetting (FIG. 2), the material is often stored in a silo (200) and fed to the production machine (300) via screw conveyors (201). The binder is introduced by manual insertion of canisters (202) filled with binder, and the construction container (104) may be prepared, for example, via rails or simply via a transport cart (204). In the process, the spatial directions of all movements cross. In many cases, movements in several or all spatial directions are possible in individual operations. This generates a large number of possible movements and collisions, which accounts for the complexity of the device.

Therefore, it was an object of the present invention to provide a device and a method requiring only a minimum of space for charging and discharging operations. Another object of the present invention was to provide a device and a method allowing the prior art disadvantages to be avoided.

### BRIEF SUMMARY OF THE DISCLOSURE

In one aspect, the disclosure relates to a method for producing three-dimensional molded parts by a layer construction method on a construction field in a construction space of a device, wherein materials are fed to and removed from the construction space and wherein the feeding and removal of all materials is effected in one spatial direction of the device.

In another aspect, the disclosure also relates to a device for producing three-dimensional molded parts by a layer construction method on a construction field in a construction space, wherein materials are fed to and removed from the construction field and wherein all supply devices are provided on the device such that feeding and removal of the materials can be effected from one spatial direction.

### BRIEF DESCRIPTION OF THE DRAWINGS

FIG. 1: Schematic representation of a prior art binder jetting method for producing three-dimensional molded parts.

FIG. 2: Schematic representation according to the prior art of a material feed and of removal of the produced molded part in a binder jetting method.

FIG. 3: Schematic representation of a device according to a preferred embodiment of the present invention.

FIG. 4: Schematic representation of a possible embodiment of a supply means for a device according to a further preferred embodiment of the present invention.

FIG. 5: Schematic representation of an interface of a supply means to the device according to a particularly preferred embodiment of the invention.

FIG. 6: Schematic representation of creating an interface in the case of interfaces according to an exemplary embodiment which differ from the system.

FIG. 7: Schematic representation of a tool for picking up a supply means according to another embodiment of the invention.

FIG. 8: Schematic representation of a system for carrying out a preferred method according to the invention.

### DETAILED DESCRIPTION

In the following, several terms will be defined more precisely. Otherwise, the terms used shall have the meanings known to the person skilled in the art.

In the sense of the invention, “layer construction methods” or “3D printing methods”, respectively, are all methods known from the prior art which enable the construction of components in three-dimensional molds and are compatible with the described process components and devices.

A “molded article” or “component” in the sense of the invention means all three-dimensional objects manufactured by means of the method according to the invention or/and the device according to the invention which exhibit dimensional stability.

“Materials” in the sense of the invention are all materials that can be supplied to and removed from the device. They include, in particular, construction materials, parts, molded articles, machine parts, excess material, maintenance parts, adjusting means, etc.

The “device” or “production machine” used for carrying out the method according to the invention may be any known 3D-printing device for layer construction which includes the required parts. Common components include coater, construction field, means for moving the construction field or other components, a metering device and heating means and other components which are known to the person skilled in the art and will therefore not be described in detail herein.

As “fluids”, all flowable materials known for 3D printing may be used, in particular in the form of a powder, slag or liquid. These may include, for example, sands, ceramic powders, glass powders and other powders of inorganic materials, metal powders, plastic materials, wood particles, fiber materials, celluloses or/and lactose powders, as well as other types of organic, pulverulent materials. The particulate material is preferably a free-flowing powder when dry, but a cohesive, cut-resistant powder may also be used. This cohesivity may also result from adding a binder material or an auxiliary material.

A “construction field” is the plane or, in a broader sense, the geometric location on or in which the particulate material bed grows during the construction process by repeated coating with particulate material. The construction field is frequently bounded by a bottom, i.e. the construction platform, by walls and an open top surface, i.e. the construction plane.

The “construction platform” serves as the basis for the layer construction method. On the construction platform, the construction job is built up which contains the parts that are the target of the production. In many production methods, said construction platform can be removed from the machine.

In some methods, a “construction container” is provided in addition to the construction platform. For example, in binder jetting, there is powder in the construction container after completion of the production run, said powder containing the desired parts. In many devices, the construction container can be removed from the production machine.

A “construction space” according to the present invention is understood to be the entire area of the device in which the layer construction process takes place.

The “print head” consists of various components. These include the print modules which are aligned with respect to the print head. The print head is aligned with respect to the machine. This allows the position of a nozzle to be assigned to the machine coordinate system.

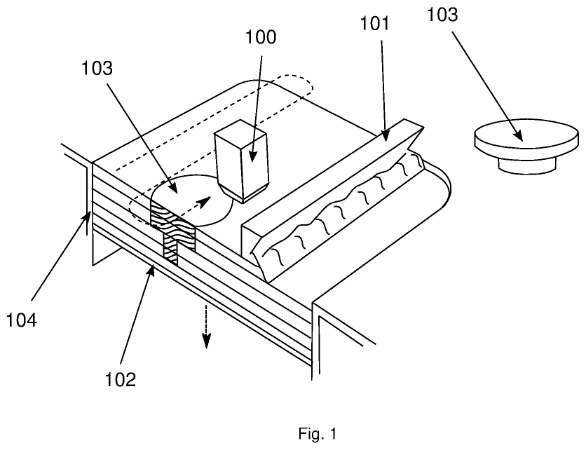

“Coater” or “recoater” means the unit by means of which the fluid is applied into or onto the construction field. The unit may consist of a fluid reservoir and a fluid application unit wherein, according to the present invention, the fluid application unit comprises a fluid outlet and a coating blade. The coater (101) may have an elongated reservoir that moves over the construction field, such as illustrated in FIG. 1. The reservoir of the coater may have an elongated-funnel shape, such as illustrated in FIG. 1.

A “spatial direction” in the sense of the present invention is understood to be an imaginary axis occupying a certain angle with respect to the coordinate system of the production machine. In the sense of this invention, it is the spatial direction in which materials are moved in the area of stations. According to the invention, there is, for example, only one sense of direction in the area of the production machine. For instance, a handling system may be installed above the production machine. Consequently, all movements in the area of the production machine must be either upward or downward movements. It is only from a certain height, depending on the height of the production machine and the material or the container, respectively, that a second movement direction can be allowed. With respect to the geometrical parameters of the production machine, the movement direction should extend at least approximately perpendicular to the edges of the production machine.

A “construction direction” in the sense of the invention is the direction in which the parts grow, i.e. gain height in many cases, during the layer construction process.

According to the present invention, an “interface” is understood to mean an interface to a device according to the invention. This may be, for example, the interface between the supply system and the materials, such as e.g. containers or tools. The interface may be mechanical, electrical and defined for fluid media (e.g. compressed air). It should be the same for all materials, containers and tools. At least, all elements should fit together, even though not all elements use all functions of the interface.

The term “further processing station” may be understood to mean a production machine or any station, including a material receiving station.

According to the present invention, a “supply system” is understood to be a system for supplying the production machine with consumable materials in one spatial direction, removing waste materials, and removing the produced articles from the production area. Preferably, the supply system also comprises a handling system for containers. These containers preferably comprise an interface whose counterpart is attached to the supply system. The containers can be moved to different positions. Certain positions perform a function and are called stations in this description.

A “tool” in the sense of this invention is a device which can be connected to the supply system and which can perform a task actively, i.e. using energy and information.

A station is presently understood to be a position of the supply system that performs a function. For example, one position is a construction container-preparing position within the production machine. The new-material supply station may also serve as an example of a station.

According to the present description, a “container” is an object of any shape which implements the interface and can receive materials. An example may be a container which contains sand particle material. Such a container may have inclined surfaces and, as the case may be, also include a second interface, e.g. to the reservoir in the production machine. The opening of the container may preferably be actuated via the supply system.

A “binder jetting layer construction method” means that powder is applied in layers onto a construction platform, a liquid binder is printed on the cross-sections of the part on this powder layer, the position of the construction platform is changed by one layer thickness with respect to the previous position, and these steps are repeated until the part is finished.

On the other hand, in “Fused Deposition Modeling (FDM) layer construction methods” the cross-sections of the part are constructed by a liquid medium which solidifies outside a nozzle, changing the position of the construction platform by one layer thickness with respect to the previous position, and repeating these steps until the part is finished.

A “laser sintering layer construction method” means that powder is applied in layers onto a construction platform, the cross-sections of the part are melted by a laser beam on this powder layer and solidified by cooling, the position of the construction platform is changed by one layer thickness with respect to the previous position, and these steps are repeated until the part is finished.

In “stereolithography layer construction methods”, the cross-sections of the part are each solidified by chemical reaction using a laser beam in a container filled with a liquid. The position of the construction platform is changed by one layer thickness with respect to the previous position, and these steps are repeated until the part is finished.

Various aspects of the invention will be described below.

One aspect of the invention relates to a method for producing three-dimensional molded parts by a layer construction method on a construction field in a construction space of a device, wherein materials are fed to and removed from the construction space. In this case, feeding and removal of all materials is done in one spatial direction of the device.

The fact that all materials are now fed to the device and removed from the device in one spatial direction reduces the required space around the device considerably, because additional space for removing/feeding, manoeuvering etc. needs to be provided only in one spatial direction.

Due to the access from only one respective spatial direction of the device, other spatial directions remain available, e.g. for maintenance purposes.

According to a preferred embodiment of the present invention, the spatial direction is provided in the direction of a build-up direction. For a vertical build direction (the layers are built up vertically on top of each other), this means that this space should be provided in the vertical direction above the device. Thus, the device does not require any additional space around the device in the horizontal direction, so that the device can be integrated, for example into a system, in a very space-saving manner.

For instance, if a supply means is installed above several production machines arranged in series, the production machines are easily accessible from two sides. This allows good separation of the safety zone around the production machines, while achieving a high spatial density of the production machines. Charging and discharging from only one spatial direction alleviates the problem of controlling such a device. The productive system can be constructed in a modular way according to the invention and allows different degrees of automation with respect to the production machines. In this context, the production machines themselves are preferably prepared for such a system, but they need not be operated jointly.

Preferably, the feeding and removal of the materials is effected via an interface on the device.

Providing an interface facilitates the attachment of the materials or of the containers, platforms or the like receiving the materials. Automation is also simplified considerably by providing an interface.

This can be simplified even further, if one or more handling devices for feeding and removing the materials can be made to engage with the device.

Such a handling device may preferably feed materials from the device to other processing stations. This can improve the automation of a method according to the invention still further.

In this context, it is quite conceivable that several devices and/or processing stations are operated jointly, with one supply system charging several devices and/or processing stations.

The feeding and removal of the plurality of devices may be implemented in a linear or circular arrangement in this case.

In another aspect, the invention relates to a device for producing three-dimensional molded parts on a construction field in a construction space, wherein materials are fed to and removed from the construction field. In this case, all supply means of the device are provided on the device in a manner allowing the materials to be fed and removed in one spatial direction.

Such a device can be employed in a very space-saving manner.

This applies, in particular, if the spatial direction for the device is provided in a direction of construction, above the direction of construction.

Even better handling is achieved by providing the device, in the spatial direction, with one or more defined interfaces for receiving the supply means.

If the device is configured such, in this case, that a construction platform and/or a construction container are provided in the device and can be fed and removed via the interface, the feeding and removal of the materials will be even easier to perform.

If a handling device is further provided that can be made to engage with the device, thereby allowing materials or containers and platforms, respectively, to be fed and/or removed, the feeding and removal can be effected automatically as well.

Providing several devices to be jointly operated and a supply system that charges several devices will allow a multiplicity of automated production processes to be carried out.

Depending on the production method and the available space, it may be advantageous to arrange the devices such that the materials can be fed and removed in a linear arrangement or in a circular arrangement.

In a still further aspect, the invention relates to the use of the above-described device in Fused Deposition Modeling processes, stereolithography, laser sintering, laser melting, multijet or polyjet modeling, high-speed sintering, multijet fusion processes and/or binder jetting.

The present invention will be explained in more detail below, with reference to examples representing preferred embodiments.

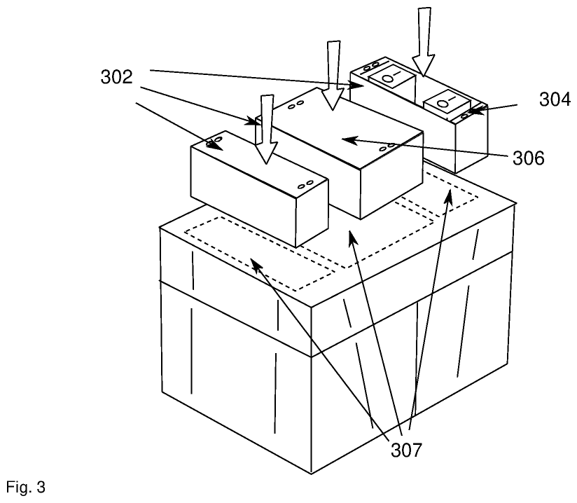

FIG. 3 illustrates a preferred embodiment of the present invention. It shows a device which is designed to produce three-dimensional parts and can carry out a corresponding method.

In this device or production machine (300), respectively, it can be seen that, according to the invention, all materials, such as e.g. consumable materials, including the parts produced by this production machine (300), can be fed or removed, respectively, in one spatial direction (303). In other words, different consumable materials are provided to the production machine from the same side of the production machine, such as illustrated in FIG. 3. For this purpose, according to the embodiment shown, containers (302) are used as parts comprising a defined interface (304) for a receptacle. Moreover, a supply means can be used which carries a counterpiece that can be locked with the receptacle, thereby allowing it to remove the containers (302) from the area of the production machine (300), deposit them in other devices and also handle containers (302) from several production machines (300). The production machine (300) may be configured for receiving a construction container (306), such as illustrated in FIG. 3. The production machine may be configured for receiving one or more construction material containers, such as illustrated in FIG. 3.

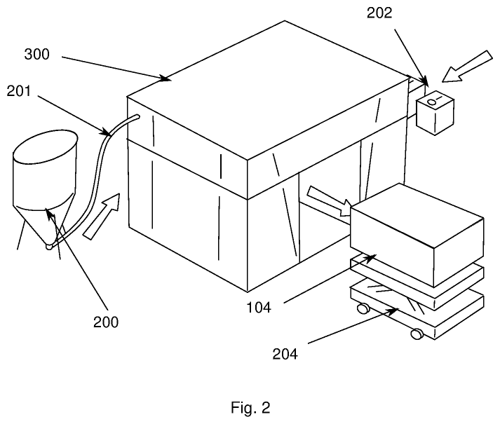

Platform-based layer construction methods are particularly suitable in the application of this invention. For example, the method according to the invention can be applied in the Fused Deposition Modeling technique, in stereolithography, in laser sintering or laser melting, in multijet or polyjet modeling, in high-speed sintering or the multijet fusion method as well as in binder jetting (FIG. 1 and FIG. 2; cf. also the above description of the prior art). The production machine may include a powder coater (101), such as illustrated in FIG. 1. The production machine may include a print head (100) such as illustrated in FIG. 1. The layer construction method may employ a construction platform (102), such as illustrated in FIG. 1. The layer construction method may employ a construction container (104), such as illustrated in FIG. 1.

For instance, a production machine (300) according to a preferred embodiment of the invention may be supplied from above, in the direction of the arrow (303), for the binder jetting method. Both the construction container (306) and the construction material containers (308), as well as spent powder material (in a container like (302)) can be fed to and removed from the machine from above. The consumable materials can be re-filled during operation of a machine.

In the embodiment shown, all device parts which transport materials are provided with a uniform interface (304). Said interface (304) may optionally be implemented by intermediate tools, too.

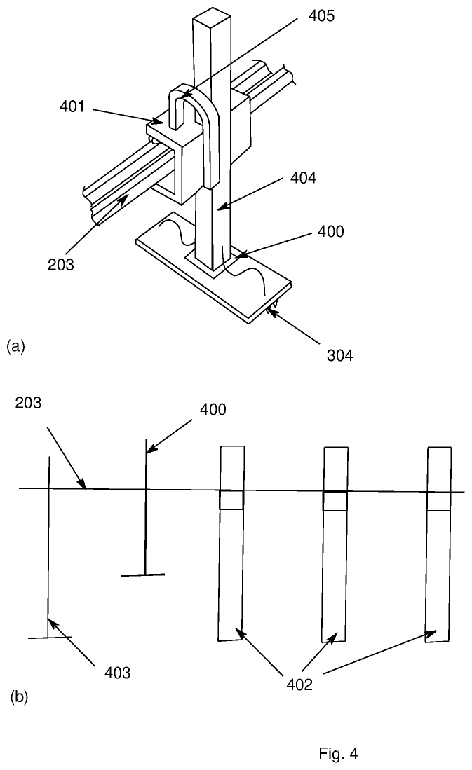

FIGS. 4a) and 4b) show that the interface (304) can be contacted by a handling device (400), thereby fixing the respective container (302, including the construction container (306)) to the handling device (400). The handling device (400) then performs movements in at least two spatial directions. The first movement serves to remove the container from the area of the production machine (300) or other equipment associated with the production process. The second movement serves the purpose of positioning relative to various positions.

The supply means is basically a rail system (203) on which a beam hoist (401) can be moved in the longitudinal direction of the supply means. The rail system may be connected, for example, to the column system (402) of a machine hall. Also, subsequently mountable feet (403) may carry the rail system.

The beam hoist has a linear module (404) mounted thereon, allowing the interface (304) of the supply system to be moved up and down. As a simplified variant, a crane rope with hooks can be used, too.

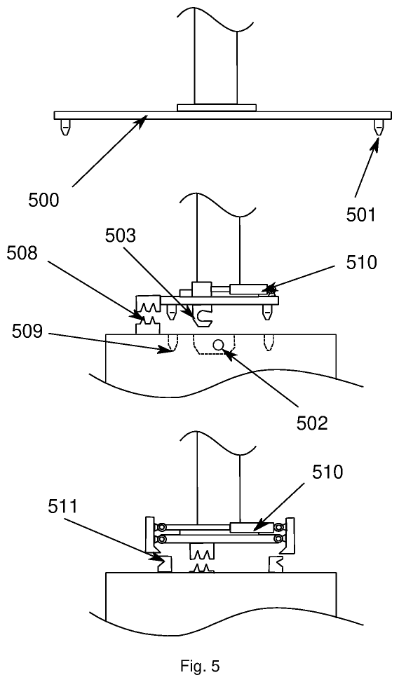

FIG. 5 shows an interface (304, 500) according to a preferred embodiment in more detail. The interface (500) is mounted, for example, to the lower end of the linear module. For example, the interface (500) may be opened or closed pneumatically. The type of connecting tool (501) may comprise bolts (502) and hooks (503) or pawls (511). In addition, the interface may be provided with devices protecting it against soiling. Cleaning devices for the counter receptacle are also useful. In this case, for example, a switchable compressed air jet can be employed.

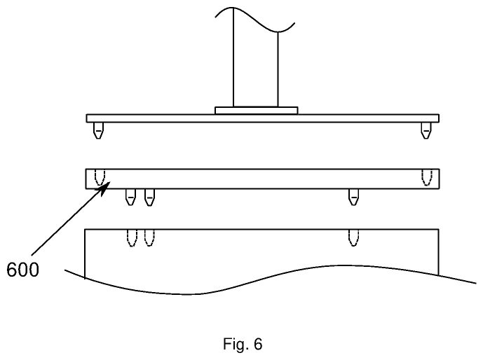

The supply means is mounted above the machine, for example. In this case, all containers and tools to be conveyed are preferably arranged in a row. If the gripper points of the interface are eccentric or have a differing “drilling pattern”, an intermediate tool (600) according to FIG. 6 will be used.

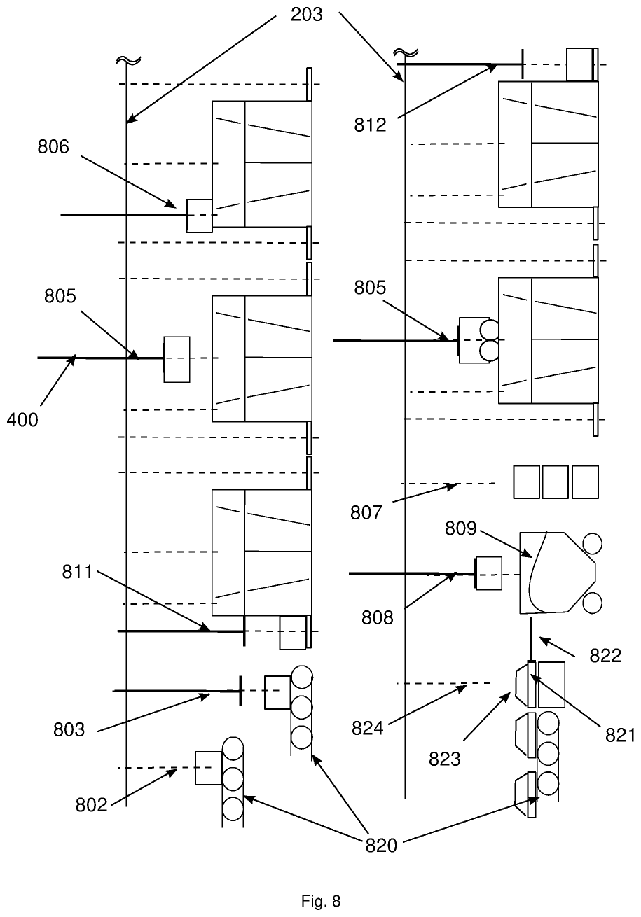

Several stations of supply means as well as discharging and charging stations of the device (300) are shown in FIG. 8. Such positions include, for example, the charging position of the construction container (805) into the machine (300), positions for charging operating resources into the machine (806, 812), corresponding positions in a combination of machines, positions of other system parts, such as an unpacking station (824), new material-charging stations (806) or tool stations (807).

As is evident from FIG. 8, a device according to the preferred embodiment shown therein is particularly suitable for operating machines in combination. In this case, a supply system is able to charge several machines. Material feeding and removal can be performed in a linear arrangement, but a circular arrangement is also possible.

For example, a receiving station for consumable material (802, 803) can be provided on the left side (at the top in FIG. 8) of such a device. This is where the respectively matching containers pass on a conveyor belt (820) into the access area of the supply means. The different materials can be provided via conveyor belts of different heights.

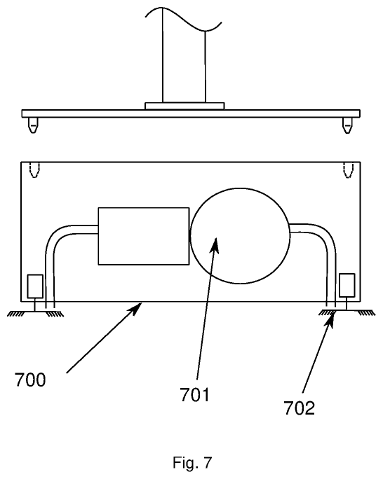

Further stations can be arranged next to the receiving station for containers. A tool station (807) may carry various devices that are not assignable to the containers or construction containers as parts. One example would be automatic cleaning means for the construction field (700) comprising a suction device (701) and brushes (702) in the production machine (300), as shown in more detail in FIG. 7.

One area may comprise means for disposal (808). In powder-based processes, used particulate material may be generated. A waste container (809) could be provided here. The respective collection container of the production machine will be emptied here by opening a flap. The supply means provides the required energy and the signal via a plug-in connection (508).

An area for disposal of liquid waste may be designed in a similar manner. However, it is also possible to simply place the container here and perform adequate disposal manually in the case of critical chemicals.

Another area could be a transfer point (824) for produced parts. There are different configurations conceivable for this. The parts can be removed from the construction container fully automatically as a block. For this purpose, a movable receiving platform (821) may be present in the construction container or on the construction platform. The platform (821) may be removed from the construction container by simple manipulators (822). Next, the construction container may be cleaned, for example, by a tool. After the procedure, the container is conveyed to a container warehouse or into a production machine by the supply means.

In order to increase the response time of the supply means, several beam hoists with linear modules may be employed. The control unit must then ensure useful coordination of the units.

### LIST OF REFERENCE NUMERALS

100 print head
101 powder coater
102 construction platform
103 produced part
104 construction container
200 silo
201 screw conveyors
202 binder canister
203 rail system
204 transport cart
300 production machine
302 container (generic container)
303 spatial direction
304 interface
306 construction container
307 openings
308 construction material container
310 top side
311 first side
312 third side (e.g., generally orthogonal to the first side)
313 fourth side (e.g., opposing the third side)
314 bottom side
315 second side (e.g., opposing the first side)
400 handling device
401 beam hoist
402 column
403 pedestal
404 linear module
405 energy supply
500 interface
501 connecting tool
502 bolt
503 hook
504 friction-fit element
505 pawl
506 protection against soiling
507 cleaning device
508 additional function plug
509 guide bore
510 cylinder
511 pawl
600 adaptor plate
700 tool for cleaning the construction field of the production machine
701 suction device
703 brushes
802 receiving station for consumable material
803 receiving station for consumable material
805 transfer point for parts/tools
806 filling point for consumable powder material
807 tool station
808 disposal station
809 waste container
810 rail system
811 removal point for overfeed powder
812 filling point for consumable fluid material
820 conveyor belt
821 receiving platform
822 manipulator
823 unpacked powder cakes
824 unpacking position
825 first movement direction
826 second movement direction

What is claimed is:

1. A system comprising:
i. two, three or more production machines for producing molded parts by a layer construction method, each production machine including a powder coater for applying a particulate material in layers onto a construction field of a removable build platform;
ii. a common conveyor for supplying the removable build platform to the production machines;
iii. an unpacking station for removing a molded part from the removable build platform; and
iv. a particulate material receiving station for receiving the particulate material;
wherein the production machines are in a linear arrangement;
wherein the production machines have a tool transfer point for receiving the removable build platform;
wherein the production machines have a particulate material transfer point for receiving the particulate material;
optionally, wherein the removable build platform is provided in a removable construction container.

2. The system of claim 1, wherein the number of production machines is three or more.

3. The system of claim 1, wherein the common conveyor moves the removable build platform with the molded part from the production machine to the unpacking position.

4. The system of claim 2, wherein the common conveyor moves the removable build platform with the molded part from the production machine to the unpacking position.

5. The system of claim 1, wherein the particulate material is moved from the particulate material receiving station to the production machines with a common conveyor.

6. The system of claim 2, wherein the particulate material is moved from the particulate material receiving station to the production machines with a common conveyor.

7. The system of claim 4, wherein the particulate material is moved from the particulate material receiving station to the production machines with a common conveyor.

8. The system of claim 2, wherein the production machines include a print head for selectively applying a liquid to a layer of the particulate material.

9. The system of claim 8, wherein the production machines have a filing point for the liquid.

10. The system of claim 9, wherein the liquid is transferred to the production machines in a container.

11. The system of claim 2, wherein the production machines have a removal point for removing overfeed particulate material.

12. The system of claim 11, wherein overfeed particulate material is moved from the production machines in a container and moved by a common conveyor.

13. The system of claim 12, wherein the system includes a common waste container for receiving the overfeed material from the production machines.

14. The system of claim 1, wherein the production machines are arranged side-by-side with a back of the production machines generally arranged on a common vertical plane.

15. The system of claim 2, wherein the system includes one or more conveyor belts.

16. The system of claim 2, wherein the system includes a tool for cleaning a construction container.

17. The system of claim 2, wherein the system includes an overhead conveyor for providing consumable material to the production machines.

18. The system of claim 1, wherein the system includes an overhead rail.

19. A system comprising:
i. three or more production machines for producing molded parts by a layer construction method, each production machine including a powder coater for applying a particulate material in layers onto a construction field of a removable build platform;
ii. a common conveyor for supplying the removable build platform to the production machines;
iii. an unpacking station for removing a molded part from the removable build platform; and
iv. a particulate material receiving station for receiving the particulate material;
wherein the production machines are in a generally circular arrangement;
wherein the production machines have a tool transfer point for receiving the removable build platform;
wherein the production machines have a particulate material transfer point for receiving the particulate material;
optionally, wherein the removable build platform is provided in a removable construction container.
